(19) United States
(12) Patent Application Publication
(10) Pub. No.: US 2008/0255889 A1
(43) Pub. Date: Oct. 16, 2008

(54) System and method for ticket selection and transactions

(76) Inventors: Dan Geisler, Tel Aviv (IL); Odeda Geisler, Tel Aviv (IL)

Correspondence Address: Dr. D. Graeser Ltd.;c/o The Discovery Dispatch, 9003 Florin Way, Upper Marlboro, MD, 20772, US

(21) Appl. No.: 12/078,550

(22) Filed: Apr. 1, 2008

Related U.S. Application Data
(60) Provisional application No. 60/907,448, filed on Apr. 2, 2007.

(51) Int. Cl. G06Q 30/00; G06Q 10/00

(52) U.S. Cl. 705/5; 705/26; 705/27; 705/14; 705/1

(57) ABSTRACT

A system and a method for selecting tickets on-line according to one or more parameters by the user. Optionally and preferably, the user is also able to purchase the tickets on-line as well. According to preferred embodiments of the present invention, the user may optionally and preferably search on-line for a ticket according to a plurality of parameters, including but not limited to, price, dates/times, exact show, type of show and/or type of seat. Optionally and preferably the user is able to view available tickets through the secondary market, preferably simultaneously with tickets in the primary market and more preferably while also viewing one or more discounts. More preferably, the original and current ticket prices of a ticket in the secondary market are indicated to the user. The user may also optionally and preferably view at least the available tickets on one or more seating charts and/or maps, which are more preferably interactive. The user may also optionally interact with a theater community.

This Application claims priority from U.S. Provisional Application No. 60/907,448, filed on Apr. 2, 2007, hereby incorporated by reference as if fully set forth herein.

### FIELD OF THE INVENTION

The present invention relates to a system and a method for ticket selection and transactions, and in particular, to such a system and method which enable the user to select a ticket according to a plurality of parameters for an event.

### BACKGROUND OF THE INVENTION

With regard to tickets for events such as theatrical productions, sporting events, concerts and/or other types of “live” events, enabling the user to purchase tickets in advance of the event and/or from a remote location can be quite advantageous to both the user and also the purveyor of the tickets. The user has the advantage of being able to purchase a ticket which might not otherwise be available, while the purveyor of tickets has the advantage of being able to sell tickets well in advance of an event and/or to gauge the popularity of the event.

“Live” events are typically those events involving actual human beings, and may include any type of event, including but not limited to stage shows, concerts, sporting events, performance art, art installations, mixed media or multi-media events, or circuses and the like. Obtaining reliable information about the popularity of a show is important. Hereinafter, the term “show” is used to indicate any type of live event for the sake of convenience.

For the user who wishes to see such a show, the difficulty arises regarding the type of seat to purchase. The relationship between the cost of a seat and the perceived “quality” of the seat is not always apparent. For example, some seats have a restricted view due to the presence of architectural features and/or scenery, yet may otherwise offer an excellent user experience.

Another problem relates to ticket availability. If seats for a show are sold out, the user may choose to purchase a seat on the secondary market, which is typically more expensive. The user must then decide whether to consider a different date for the same show or alternatively a different show, a decision which may be hampered by restrictions in time (for example, a visitor to a city such as New York City, N.Y., USA may only be present for one week and so can only view shows during that week). Thus, the decisions of the user may be influenced by many, potentially competing, factors.

Currently, tickets are available for sale through a number of different Web-based vendors. Such vendors permit users to purchase tickets in advance for shows, through either the primary market (ie the initial sale of a ticket, either with full or discounted price from the producer of the show or from the show's official box office) or the secondary market (ticket resale or sale by ticket brokers). However, nearly all of these web sites are set up for the convenience of the vendor, rather than of the user. Information about the actual seat being sold is minimal and the user often has to look through many different web pages and perform repeated searches before obtaining the desired information. Thus, there is clearly a need for a better system and method for selling tickets according to the perspective of the user.

### SUMMARY OF THE INVENTION

There is an unmet need for, and it would be highly useful to have, a system and a method for a simple web-based user interface, which enables the user to quickly and easily obtain information about available tickets, including but not limited to price and the type of seat.

There is also an unmet need for, and it would be highly useful to have, a system and a method for providing detailed information about the type of seat being sold with each ticket, particularly with regard to the user experience of the show when sitting in the seat.

The present invention overcomes these drawbacks of the background art by providing a system and method for selecting tickets on-line according to one or more parameters by the user. Optionally and preferably, the user is also able to purchase the tickets on-line as well.

Tickets may optionally be purchased on-line as is known in the art. Examples of various types of online payment mechanisms include, but are not limited to, e-money cards and accounts, credit cards, and micropayment mechanisms of various types. Alternatively, tickets may optionally be purchased through any other route, including but not limited to, by telephone, from a physical theater box office.

According to preferred embodiments of the present invention, the user may optionally and preferably search on-line for a ticket according to a plurality of parameters, including but not limited to, price, dates/times, exact show, type of show and/or type of seat, and/or type of ticket market.

It is known in the art to sell tickets through different types of markets. The primary market includes tickets sold through the “box office” or other direct sellers of tickets. The secondary market includes tickets sold through ticket brokers or ticket resellers, who purchase from the primary market (frequently although not necessarily in blocks of multiple tickets) and then sell the tickets to consumers who wish to view the show.

The user is preferably able to view available tickets from both the primary and secondary markets, optionally simultaneously or alternatively according to some type of order (for example, first viewing tickets from the primary market, followed by viewing tickets from the secondary market).

Optionally and more preferably, information about discounts, special purchases of tickets and other price related information are provided to the user. Optionally and more preferably, the user is able to view information about discounted tickets in the primary market and also optionally in the secondary market, most preferably while simultaneously viewing information about tickets in the primary and secondary market (whether with or without a discount or special price).

The user is preferably able to view a combination of available ticket information from a plurality of sources, such as a plurality of ticket exchanges, and/or a plurality of primary and/or secondary market sources. More preferably, for each show, the user is able to view tickets from the primary market source (or sources) and from a plurality of secondary market sources.

The user is preferably able to view a combination of available ticket information from a plurality of sources via a map. The map optionally illustrates the location, such as a hall, in which the show takes place. Optionally a filter can be used for displaying only the available seats for specific dates or duration, or a specific show or a specific price, or range of prices, from the primary market, or the secondary market, or any combination of the criteria described herein, or any other criteria.

When a filter according to a period of time is chosen, date filtering is optionally available within the map. Such filtering optionally enables the user to view seats for a specific day only. For example if duration of March 1 to March 3 was chosen, then the user can optionally use a filter to display on the map only the seats that are available for March 1^{st}. When a range of prices filter is chosen, for example, price filtering is optionally available. Such filtering optionally enables the user to view seats for a specific price only. For example if a range of $100-$200 was chosen, then the user can optionally use a filter to display on the map only the seats that are available for $100.

The map can optionally be filtered to display seats in different colors according to their prices, quality, or any other criteria. For example, if a price criterion is chosen, full price tickets can optionally be colored in yellow, while discounted tickets can optionally be colored in other colors, if quality filter is chosen, high quality seats can optionally be colored in red, while lower quality seats can optionally be colored in different colors. If both filter and price are chosen, then each combination of color and price can optionally be colored differently. For example high quality and full price seats optionally are colored in blue.

The term “quality” is a subjective measure, which may optionally be determined qualitatively or quantitatively. For example, a plurality of parameters may optionally be combined to determine the quality of seat, including but not limited to, location, reviews of the seat quality by audience members, whether the view is partially obstructed and so forth.

The user can optionally determine the exact place (row, seat number, section etc) of a seat in the map by specifying its location. Clicking on the desired seat, or using any other pointing mechanism, enables the user to purchase the ticket for this seat, or read comments and details about the seat, or view a photography of the seat and the landscape. The user can optionally view details about each seat such as the availability days, the rating, comments from other user etc.

Preferably, for each secondary market ticket, the original price of the ticket in the primary market (ie the price had the ticket been sold directly to the consumer in the primary market) is indicated, so that the user can see whether there is a difference in price between the current ticket price in the secondary market and the previous price in the primary market, and if so, how much the difference is.

Each display of ticket information preferably includes information about the seat itself, optionally including the general seat location (such as ground floor, first balcony, second balcony etc) and preferably also including the seat row and number. Other information about the seat is optionally and preferably also included as described in greater detail herein.

Each display of ticket information also preferably includes information about the show itself, including the title, optionally a brief summary of the content of the show and also optionally a rating of the show. Optionally and more preferably, one or more reviews of the show may also be displayed, whether user review(s) and/or review(s) by one or more professional critics. Additional information about the show may also optionally be included as described herein.

The search filters preferably enable a plurality of different types of parameters to be searched, optionally and more preferably combining at least certain aspects of the information described herein, including but not limited to show dates, number of seats, section of the theater, city, availability of location info and so forth.

According to other preferred embodiments of the present invention, the user may optionally view one or more user reviews of a particular seat in a particular theater (and/or of a group or type of such seats) in order to consider the user experience of viewing the show from that seat. Alternatively or additionally, the user may optionally search for one or more seats according to the user experience, which is preferably characterized according to a plurality of parameters. According to optional but preferred embodiments of the present invention, the user may optionally view one or more seating charts and/or maps, which is optionally and most preferably interactively linked to the seating information. Other information related to seat quality is optionally provided as described herein.

According to other preferred embodiments of the present invention, the system optionally and preferably provides a wizard from which the user can buy tickets. The wizard is an interactive user interface element that leads the user through a sequence of dialogs. The wizard preferably enables the user to chose the show from a list of shows, and, optionally, to choose the type of market which can be primary, or secondary or any other type of market, or a combination thereof, the date or plurality of days, a price or a range of prices and any other parameters that are relevant for buying a ticket. After choosing all of the desired parameters, a map is optionally displayed, showing all the available tickets that meet the chosen criteria. The user can view information about the seat and pay for the seat as described before.

According to other preferred embodiments of the present invention, the system enables the purchasing of discount tickets from the primary market, using a discount code. Primary market providers typically sell the discount tickets for selected performances for which they expect unsold seats by distributing discount codes. These codes are often (but not necessarily) applicable for the mid-week performances, if a show has a discount price in the primary market; the system optionally displays the discount code of the selected show. The user can use this code for buying the ticket through a telephone order, through one of the ticketing companies such as Ticketmaster, or optionally by connecting an on-line ticketing company, such as ticketmaster.com, telecharge.com or any other company, via the system. The user may also optionally present the discount code by ordering through another mechanism, for example by optionally by printing the discount code from the website and presenting it to the theater box office and/or sending it by facsimile or regular mail, and so forth. The user can optionally enroll through the system for receiving discount codes by email.

According to other preferred embodiments of the present invention, the system may optionally be used to generate new maps and map types and assign them to a specific theater or other performance location. The maps can be generated by optionally using a wizard, or any other method. The user is able to choose the type of location (such as stadium, opera theater, concert theater and etc) from a list of templates and then optionally define the section used (such as balcony etc), number of rows and lines per each section, the quality of each seat and any other criteria. This feature and/or tool can be optionally used by the theater, or by the general public, or by any entity that has the knowledge about the location structure.

According to other preferred embodiments of the present invention, the system can automatically generate comments regarding seats, shows, theaters, or any other entities in the system, by optionally using text mining for combining comments received from multiple sources such as reviews from audience members and/or other members of the theater community, newspapers etc. Text mining is a process of deriving high quality information from text. High quality information is typically derived through the dividing of patterns and trends through means such as statistical pattern learning. Text mining usually involves the process of structuring the input text (usually parsing, along with the addition of some derived linguistic features and the removal of others, and subsequent insertion into a database), deriving patterns within the structured data, and finally evaluation and interpretation of the output. For this embodiment of the present invention, preferably the text mining includes a dictionary of words and terms with predetermined interpretations.

According to other preferred embodiments of the present invention, the system provides statistical information which helps the ticketing companies or any other entities that are involved in this market to better understand the market and increase the selling by, for example, changing the pricing in certain dates etc. For example, displaying statistical analyses of shows for which the tickets for the primary market are cheaper from the tickets for the secondary market, statistical analyses about the number of purchases with regard to the date of the performance, or with regard to the date of the purchase or with regard to the gender or the age of the purchaser, the type of the theater or any other feature. Statistical information can also be used, for example, for analyzing the effectiveness of lowering the price. Any other analyses that are based on the information in the system can optionally be generated and displayed. The statistical information is preferably available for authorized person such as person who is involved in pricing the tickets in a company that sells tickets. This information is preferably graphically displayed.

By “online”, it is meant that communication is performed through an electronic communication medium, including but not limited to, telephone voice communication through the PSTN (public switched telephone network), cellular telephones or a combination thereof, exchanging information through Web pages according to HTTP (HyperText Transfer Protocol) or any other protocol for communication with and through mark-up language documents; exchanging messages through e-mail (electronic mail), messaging services such as ICQ™ for example, and any other type of messaging service; any type of communication using a computational device as previously defined; as well as any other type of communication which incorporates an electronic medium for transmission.

Unless otherwise defined, all technical and scientific terms used herein have the same meaning as commonly understood by one of ordinary skill in the art to which this invention belongs. The materials, methods, and examples provided herein are illustrative only and not intended to be limiting. Implementation of the method and system of the present invention involves performing or completing certain selected tasks or stages manually, automatically, or a combination thereof. Moreover, according to actual instrumentation and equipment of preferred embodiments of the method and system of the present invention, several selected stages could be implemented by hardware or by software on any operating system of any firmware or a combination thereof. For example, as hardware, selected stages of the invention could be implemented as a chip or a circuit. As software, selected stages of the invention could be implemented as a plurality of software instructions being executed by a computer using any suitable operating system. In any case, selected stages of the method and system of the invention could be described as being performed by a data processor, such as a computing platform for executing a plurality of instructions.

Although the present invention is described with regard to a “computer” on a “computer network”, it should be noted that optionally any device featuring a data processor and/or the ability to execute one or more instructions may be described as a computer, including but not limited to a PC (personal computer), a server, a minicomputer, a cellular telephone, smart mobile telephone, a smart phone, a PDA (personal data assistant), a pager, TV decoder, game console, digital music player, ATM (machine for dispensing cash), POS credit card terminal (point of sale), electronic cash register. Any two or more of such devices in communication with each other, and/or any computer in communication with any other computer, may optionally comprise a “computer network”.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a schematic block diagram of an exemplary, illustrative system according to the present invention;

FIG. 2 is a flowchart of an exemplary, illustrative non-limiting method according to the present invention for ticket selection;

FIG. 3 is a flowchart of an exemplary, illustrative non-limiting method according to the present invention for enabling ticket selection according to FIG. 2;

FIG. 4 shows an exemplary system diagram for providing seating chart information to a user;

FIG. 5 shows a schematic diagram of an exemplary, optional but preferred embodiment of a community according to the present invention;

FIGS. 6-9 are screenshots of an exemplary, illustrative non-limiting implementation of the present invention with regard to a web site known as “BroadwayBox.com”, constructed by the present inventors and owned in common with the present invention;

FIG. 10 shows a schematic diagram of the map usage in the system;

FIG. 11 is a diagram describing the usage of the wizard;

FIG. 12 is a diagram showing an exemplary method for purchasing a ticket using a discount code;

FIG. 13 is a flow diagram showing an exemplary method for generating a map;

FIG. 14 is a flow diagram showing an exemplary method for generating statistics; and

FIG. 15 is a flow diagram showing an exemplary method of generating comments and reviews.

### DESCRIPTION OF THE PREFERRED EMBODIMENTS

The present invention is of a system and a method for at least selecting tickets on-line according to one or more parameters by the user. Optionally and preferably, the user is also able to purchase the tickets on-line as well.

According to preferred embodiments of the present invention, the user may optionally and preferably search on-line for a ticket according to a plurality of parameters, including but not limited to, price, dates/times, exact show, type of show and/or type of seat, quality of seat and/or “view” from the seat, and/or type of ticket market. These embodiments are described in greater detail below, starting with a discussion of various types of tickets (including primary vs. secondary markets and so forth) and then discussing various parameters related to the seats themselves, optionally including a map to enable the user to more easily select a seat or seats.

It is known in the art to sell tickets through different types of markets. The primary market includes tickets sold through the “box office” or other direct sellers of tickets. The secondary market includes tickets sold through ticket brokers or ticket resellers, who purchase from the primary market (frequently although not necessarily in blocks of multiple tickets) and then sell the tickets to consumers who wish to view the show.

The user is preferably able to view available tickets from both the primary and secondary markets, optionally simultaneously or alternatively according to some type of order (for example, first viewing tickets from the primary market, followed by viewing tickets from the secondary market).

The user is preferably able to view a combination of available ticket information from a plurality of sources, such as a plurality of ticket exchanges, and/or a plurality of primary and/or secondary market sources. More preferably, for each show, the user is able to view tickets from the primary market source (or sources) and from a plurality of secondary market sources.

Preferably, for each secondary market ticket, the original price of the ticket in the primary market (ie the price had the ticket been sold directly to the consumer in the primary market) is indicated, so that the user can see whether there is a difference in price between the current ticket price in the secondary market and the previous price in the primary market, and if so, how much the difference is.

For at least certain secondary market tickets, the seller may optionally place one or more restrictions on the number of tickets which may be sold as a block, for example blocking sales of an odd number of tickets (from a total group of tickets which is an even number) and/or blocking sales which would leave only one ticket remaining in the block, or any other restrictions which the seller wishes to place on sales of tickets. Optionally and preferably, the search engine considers such information when provided by the ticket seller and/or indicates this information to the user when displaying the search results.

According to other preferred embodiments of the present invention, one or more discounts and/or special purchase price information may optionally and preferably be displayed to the user, who may optionally choose to search for tickets at least partially according to the availability of such discounts and/or special purchase prices. More preferably, the discount is provided according to a special code, which the user enters to the on-line site when purchasing the tickets and/or gives to the ticket seller for off-line purchases (see below for an extended description of different purchase modes).

According to preferred embodiments of the present invention, the user may optionally and preferably search on-line for a ticket according to a plurality of parameters, including but not limited to, price, dates/times, exact show, type of show, availability of exact seat location and/or type of seat (optionally including quality of seat) and/or number of tickets. A plurality of different choices are preferably displayed to the user according to the degree to which such choices fit the selected parameters. Information regarding each choice is also preferably displayed to the user, including but not limited to one or more of the price of the seat, actual seat or at least type of seat, quality of the seat (according to both objective and non-objective parameters as discussed in greater detail below), date and time of the show and so forth. The user may then optionally choose to revise the search, if none of the choices appears suitable, and/or to change a parameter such as price for example.

With regard to parameters, price (monetary parameter) was previously discussed. As noted above, another parameter refers to the date on which the show occurs. The different “dates” may also optionally include different times of the day (matinee vs. evening performance for example), specific hours of the show, as well as days of the week and/or specific calendar dates or a range thereof.

Also as noted above, another parameter refers to an exact show or type of show. If the user wishes only to view information related to an exact show, then the user indicates this choice and only tickets for that show are displayed. However, if the user wishes to view a type of show (comedy, drama, musical, family-oriented or any other type of interest) then the user may optionally indicate a type of show as a search parameter. Tickets will then be displayed for shows which match that type. The user may optionally add or reject shows in the selected category as being suitable/unsuitable.

According to other preferred embodiments of the present invention, the user is also able to search and select tickets for a particular show or type of show according to non-monetary parameters, which are parameters other than price, including but not limited to, objective parameters and non-objective parameters. Objective parameters may optionally include but are not limited to the “view” available from seat (which may for example be partially blocked by scenery), whether the seat is wheelchair accessible, location within the theater (for example under an overhanging balcony, on an aisle), distance from the stage, viewing angle and so forth. Non-objective or qualitative parameters include but are not limited to seat quality, review of the seat by one or more other users, ability to easily see all of the interesting action on stage, whether the seat is cold or hot in relation to air-conditioning, “comfort” level of the seat, leg-room of the seat, ability of the user to see and/or hear (for example at some seats it may be possible to hear the operation of the stage mechanics), any restrictions or special requirements of the user and so forth regarding the user; all of which relate to the user experience and are hence subjective. The user may optionally and preferably view one or more user reviews of a particular seat in a particular theater (and/or of a group or type of such seats) in order to consider the user experience of viewing the show from that seat.

Optionally and preferably, the user experience may be at least partially determined according to a seating chart, which preferably includes a two or three dimensional view of the show location, which may for example be a theater (but which may optionally be any such location, including but not limited to a sports arena or stadium, a concert hall or other concert venue, a performance art space and the like). The three dimensional view optionally and preferably permits the user to view the seat from at least the perspective of the viewer sitting in the seat to view the show, but more preferably permits a variety of views to be shown so that the user may optionally and preferably view the seat from a plurality of angles and views. Preferably the user is also able to view pictures or images that show how the theater looks from a certain seat, how various parts of the show appear and so forth.

Optionally and more preferably, the seating chart is “linked” to information about each seat (where available), such that for example the user may optionally and most preferably “click on” or otherwise select a seat as displayed to the user, thereby causing information about the seat to be displayed. In place of direct selection, the user may optionally manually enter the seat information, for example from the ticket selection search as described above. The seat preferably is displayed on the map according to a seat icon, which may also optionally and preferably include one or more symbols (including color) relating to one or more seat parameters. The reverse type of linking may also optionally be performed, in which the user receives ticket information and then requests information about the seat and/or a view of the seat on a seating map or chart by “clicking on” or otherwise selecting the ticket information.

According to other preferred embodiments of the present invention, the seating chart features a “map” according to one or more of price, availability and/or perceived value of the seat. Perceived value may optionally be determined at least partially according to a general method as described herein and/or may also incorporate one or more user preferences, also as described herein. The map may optionally feature colors, patterns, symbols and/or other indicators for the user to show the desired information. Preferably the user may change the map to show requested information, such as changing from price to perceived value and so forth. The map may also optionally and preferably be constructed as for a “heat map”, showing a gradient of strength for any parameter of interest to the user as described herein.

It should be noted that when purchasing tickets “on-line”, such a purchase may optionally be made directly through the same site which provides information about the tickets according to the present invention, and/or alternatively through the ticket selection site provided by the initial or direct ticket seller in the primary market or as provided by the reseller in the secondary market, and/or additionally or alternatively may be made off-line, all of which are encompassed herein as embodiments of the present invention.

According to preferred embodiments of the present invention, the user is preferably able to personalize the search according to one or more preferred parameters, which most preferably are saved at the on-line site. For example, if the on-line site is a web site, the user is preferably able to “log-in” or otherwise identify him or herself to the web site, after which one or more of the user's saved parameters are preferably displayed to the user. For example, the saved parameters may optionally be obtained through identifying the user according to a “cookie” for example. The user may then optionally select one or more (or all) parameters for performing one or more searches for tickets. Alternatively or additionally, the user may choose to change one or more parameters for performing the search(es).

Optionally and preferably, a user provides personal details about him or herself to the on-line site in order to receive the above personalized experience. Such details may optionally include one or more of the user's name, age, occupation, theater interests, shows which the user has seen (and which were enjoyed and which were not enjoyed), show(s) which the user would like to see and the like; optionally and more preferably, such details permit the user to receive targeted advertising on or through the on-line site. If the on-line site is a web site, then the targeted advertising may optionally be displayed to the user upon logging in or otherwise identifying the user to the web site as described above.

Alternatively or additionally, a user who has provided such details may optionally receive a newsletter with information, preferably including one or more special show “deals” according to the preferences of the user, more preferably also including one or more targeted information and/or advertisements. Such targeted advertisements may optionally also include information about one or more show-related services as described herein, and/or may be used to advertise upcoming shows which may be of interest to the user.

According to other preferred embodiments of the present invention, the user may optionally join a community of other users, preferably in order to obtain information about user opinions. Optionally and preferably, the user may choose to join a group of users to order tickets as a group for a particular show and/or invite other member(s) to view a show together (regardless of how tickets are ordered). The user may also optionally and preferably search for other member(s) having similar interest(s) and/or preference(s), for example according to a show which was enjoyed and/or type of shows that are of interest and/or to find out about a show which another member wishes to view.

According to other optional embodiments of the present invention, the selection of one or more tickets for one or more shows may optionally be combined with one or more additional services, termed herein “show-related services”. Alternatively, such “show-related” services may optionally be provided separately according to the system and method of the present invention as described herein.

By “show-related” it is not meant that there is a direct tie or link between the show and the service, but that rather such show-related services may be expected to be of at least potential interest to the user who has purchased one or more tickets for a show. Examples of such show-related services include but are not limited to, travel-related services, restaurant display and/or selection services and the like.

By “travel-related services” it is meant any service that could be useful for the traveler, including but not limited to hotel selection, hotel room selection, transportation selection and the like. Hotel selection is well known in the art and there are a number of web sites which provide such a service. However, hotel room selection, preferably combined with one or more user reviews about one or more blocks of rooms and/or specific rooms, is not known the art and is a travel-related service which may optionally be implemented according to the system and method of the present invention as described herein, and/or combined with such a system and method for ticket selection.

By restaurant display and/or selection services, it is meant any service which assists the user in selecting a restaurant. Optionally and preferably, such a service is combined with the ticket selection system and method according to the present invention, for example to allow the user to make a reservation at a restaurant at a location and time which is suitable for the show (for example before or after the show). Preferably the service includes such information as one or more of the length of time to be seated, the length of time to be served (more preferably depending on the number of courses) and so forth. The service may also optionally include one or more reviews of restaurants, whether professional and/or amateur in nature, for example regarding the quality of the food and of the dining experience.

Optionally and more preferably, the restaurant selection service includes information about specific tables and assists the user in selecting an appropriate table depending upon the desired dining experience. For example, a user may wish to “see and be seen” or alternatively the user may prefer a quiet dining experience. The service may optionally allow the user to make a reservation directly, preferably for the desired table, but may alternatively require the user to contact the restaurant directly (or a combination thereof).

Also optionally and preferably, information is provided about the relative location of the restaurant or hotel, in relation to the location of the show. Such information may optionally be provided either to enable the user to select a restaurant or hotel in relation to the location of the show, or alternatively to select a show in relation to the location of the restaurant or hotel.

The principles and operation of the present invention may be better understood with reference to the drawings and the accompanying description.

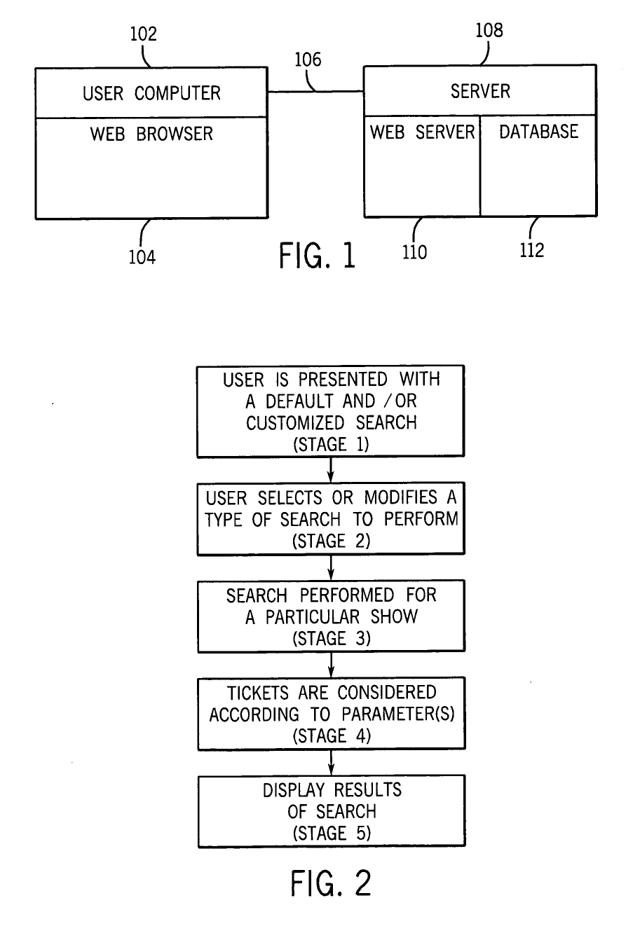

Referring now to the drawings, FIG. 1 is a schematic block diagram of an exemplary, illustrative, non-limiting system according to the present invention. As shown, a system 100 features a user computer 102, of which only one is shown although any number may optionally be included. User computer 102 is operated by a user (not shown) who wishes to select one or more tickets. User computer 102 preferably features some type of on-line interface, such as a web browser 104 as shown. Web browser 104 preferably displays ticket information as described herein, and optionally also seat information and/or other types of information as described herein.

User computer 102 is preferably able to access ticket information through a network 106, including but not limited to the Internet (although is optionally any computational network may be used). Network 106 is also connected to a server 108 for providing ticket information. Server 108 preferably features a web server 110 for providing web page information to web browser 104 and a database 112 for storing ticket information. Optionally, server 108 may comprise a plurality of computers and/or databases (not shown), and may also optionally be capable of direct or indirect communication with other computers (for example one or more servers of ticket sellers).

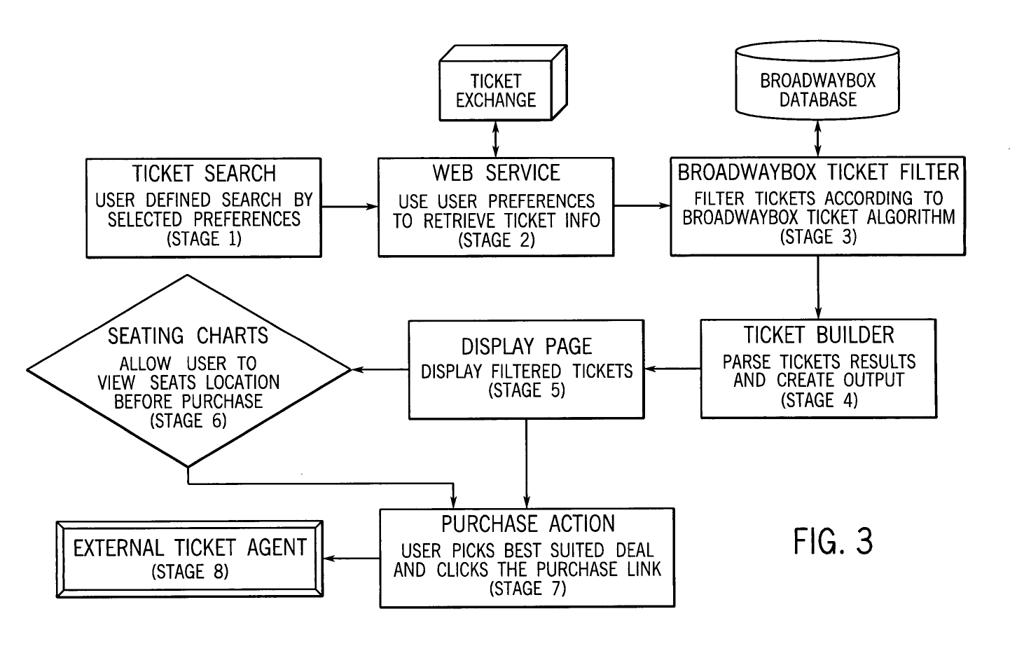

FIG. 2 is a flowchart of an exemplary, illustrative non-limiting method according to the present invention for ticket selection. As shown, in stage 1, user is presented with a default and/or customized search. In stage 2, the user selects or modifies a type of search to perform, including but not limited to by category of show, by specific show, by dates or a combination thereof.

In stage 3, the selected search is (as a non-limiting example) a search for a particular show according to a range of dates.

In stage 4, tickets for the show according to the range of dates are considered for the search, optionally according to one or more additional parameters, including but not limited to availability of a discount, quality of the seat, whether tickets are available in the primary or secondary market, and so forth. The user may optionally choose to weight various parameters and/or to indicate minimally required parameters (for example, the price could be limited to a maximum price).

In stage 5, results regarding tickets fitting the selected parameters are displayed. If the tickets are in the secondary market, then the displayed results preferably include the original price as well as the current price (as the latter is typically higher).

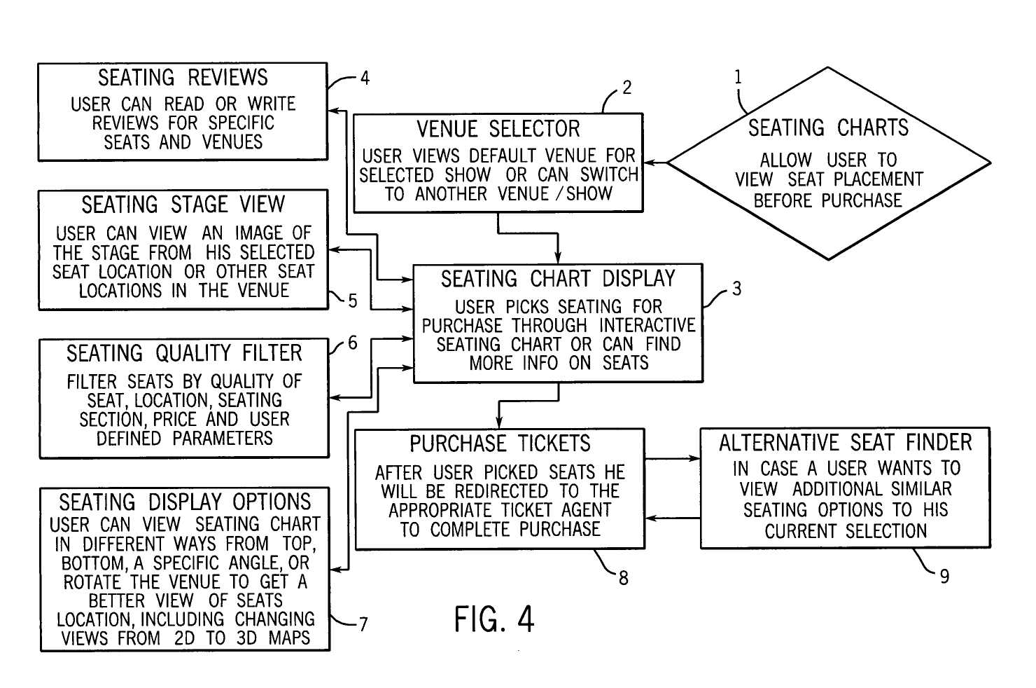

FIG. 3 is a flowchart of an exemplary, illustrative non-limiting method according to the present invention for enabling ticket selection according to FIG. 2. As shown, in stage 1 the user defines the search according to one or more selected parameters. In stage 2, a web service uses these selected parameters to select one or more tickets from a ticket database as shown (labeled “ticket exchange”). Optionally, the ticket exchange may only provide information related to show times, available tickets and prices (also preferably including availability of discounts, and whether tickets are available in the primary or secondary market).

In stage 3, a ticket filter preferably accesses a filter database for obtaining other types of information, more preferably including information for objective and non-objective parameters as described above, as well as more preferably including information related to non-monetary parameters. If the user has specified one or more weights and/or minimum parameters as described above, then the ticket filter preferably sorts the tickets according to these parameters. Alternatively or additionally, the ticket filter may sort the tickets according to a pre-determined application of the parameters (for example, by automatically lowering the place in the displayed list of seats for any seat with an obstructed view or for which the user perceived quality was determined to be low).

In stage 4, a ticket builder preferably parses the results and creates an output set of information. Parsing may optionally be performed in order to permit results from a plurality of sources and/or formats to be uniformly structured. This output set of information is preferably prepared for display. In stage 5, the ticket information is displayed to the user, preferably in both a table format and also as a seating chart. The user may then optionally select one or more tickets for obtaining further information.

Optionally and preferably, in stage 6, the user is shown one or more seating charts related to the selected tickets in stage 5, indicating the location of the seat. The seat itself is preferably highlighted in some manner, more preferably with a symbol, color or other information related to the seat quality. More preferably, the seat itself is linked to user reviews and other information about the seat, which may optionally be displayed immediately and/or upon moving the mouse or other pointing device of the user over the seat and/or upon “clicking on” or otherwise selecting the seat with the mouse or other pointing device of the user. If the user wishes to change the choice of seat, then preferably the user is able to select such a seat to obtain information about ticket availability, price and the like.

In stage 7, once the ticket(s) of interest have been selected by the user, the user is preferably able to indicate a purchase action, for example by clicking on or otherwise selecting a button or other GUI gadget on the web page. In stage 8, the user is able to purchase the tickets, optionally through an external (third party) web site. For example as shown the external web site may optionally be an external ticket agent, through which the purchase is completed.

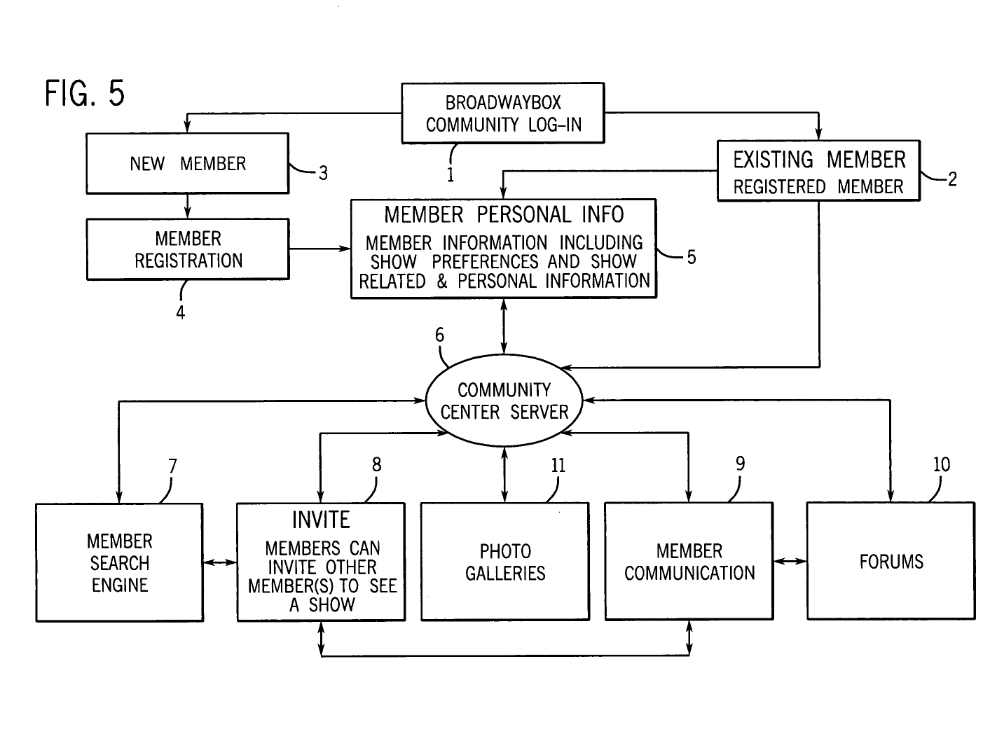

FIG. 4 shows an exemplary system diagram for providing seating chart information to a user. It should be noted that this is a logic diagram for a plurality of software modules which could optionally be implemented on a computer or a plurality of computers, such as on a server for example. A seating chart module (1) is preferably provided as an interface to the user for enabling the user to request information about a seat or plurality of seats, and/or for all seats in a section of a theater or for all seats in the theater.

Upon requesting such information, a venue selector (2) may optionally and preferably provide information regarding the default venue (location) for a particular show. Alternatively, the user may optionally select a different venue for the show and/or a different show.

Once the venue and show have been determined, the user is preferably able to view a seating chart through a seating chart display interface (3). The user may optionally view a seating chart for the venue itself without relation to a particular show, but preferably views seating information in relation to both the venue and the show.

The seating chart display is preferably interactive, such that the user is preferably able to view information about each seat and to select seat(s) through the display. Such interactive information optionally and preferably includes (but is not limited to) one or more of the following. The user can optionally and preferably submit a review for a seat and/or read a user review about a seat (seating review module (4)). The user can also optionally and preferably examine a view of a seat through a seating stage view module (5), which more preferably includes viewing an image of the stage from the selected seat location and/or other seat locations in the venue. Such a view may optionally be schematic but is more preferably three dimensional.

A seating quality filter module (6) preferably allows the user to filter through various seating options according to one or more of the quality of the seat, the location of the seat, the seating section, price and/or user defined parameters according to one or more user requests as described herein.

The above seating chart displays may optionally and preferably be augmented and/or implemented according to seating display option module (7), which preferably enables the user to view the seating chart in different ways: for example, from the top or bottom of the seating area, at a specific angle, and/or by rotating the display of the venue in order to view the seat location, more preferably including changing views from two dimensional to three dimensional displays.

Seating chart display module (3) preferably uses one or more of modules 4-7 in order to provide the user with more information regarding the qualitative, more subjective aspects of the user viewing experience, such that the user may optionally consider in advance whether a particular seat will provide an enjoyable viewing experience for a particular show and venue. If the user locates one or more suitable seat(s), then preferably a ticket purchase module (8) either directly enables the user to purchase the ticket(s) or alternatively directs the user to a ticket agent for ticket purchase. At the time of purchase, the user may optionally and preferably use an alternative seat finder module (9) to locate alternative seating selection(s) to those seat(s) being considered for purchase.

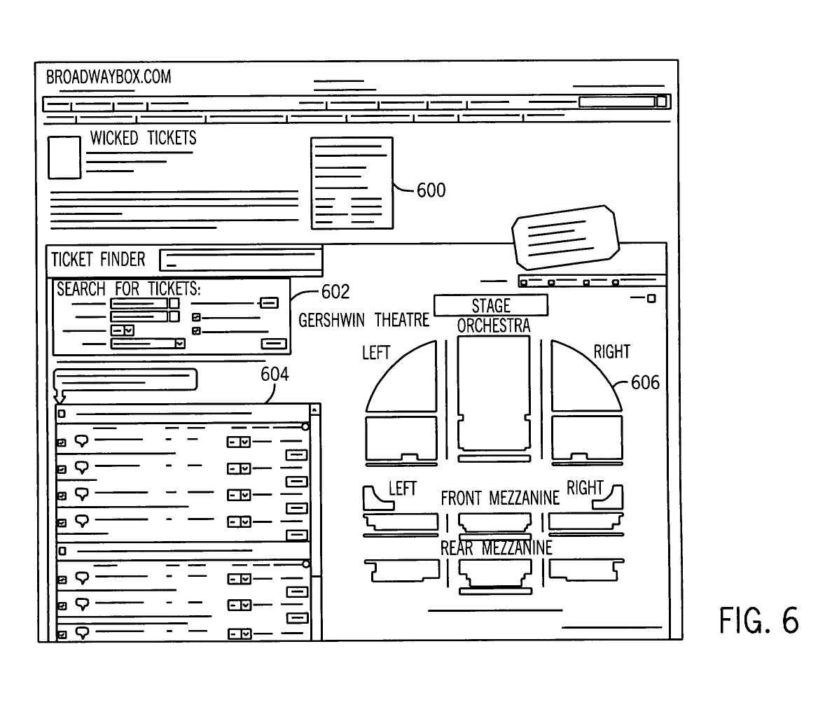

FIG. 5 shows a schematic diagram of an exemplary, optional but preferred embodiment of a community according to the present invention. The diagram is a highly schematic logic diagram and as such, describes the overall process of interaction between functional modules, which may optionally be implemented in a variety of ways (for example as software, firmware, hardware or a combination thereof).

The user may optionally and preferably log-in to a login module (1) as shown, for example by entering a user name and password for known users (module 2), or by registering for new users (modules 3 and 4). A known user may optionally identified according to a “cookie” for example for the log-in process.

Upon registering, the user optionally and preferably provides personal details about him or herself to the on-line site (through module 4). Such details may optionally include one or more of the user's name, age, occupation, theater interests, shows which the user has seen (and which were enjoyed and which were not enjoyed), show(s) which the user would like to see and the like. The details may also optionally include information about one or more preferred search parameters as described previously.

This user information is preferably saved at the on-line site, for example through a user information module (5). Access to such information as well as to the information of other members of the community is preferably provided through a community center server (6). A registered user may, preferably upon log-in, view information related to other members of the community as well that of the registered user. Alternatively, as described herein, some information may optionally be available to all users, whether registered or not and whether logged in or not.

Community center server (6) preferably enables members to search for information about other member(s) through a search engine (7). Search engine (7) preferably supports searching for other member(s) according to a plurality of parameters, such as show preferences or personal information, and/or according to shows viewed and/or not viewed by the user, and/or shows the user wishes to see, and so forth. Once a member has been located (and/or as a separate function), the user may optionally invite the member(s) to view a show together through an invitation module (8), optionally and preferably by purchasing tickets as a group or alternatively by purchasing tickets separately but for the same performance (most preferably in some type of coordinated manner).

Communication between members, for example for the above invitation, is preferably supported by a communication module (9). Members may optionally send internal electronic messages to each other and/or chat with one another, and/or send messages to their external e-mail addresses, for example. Optionally, VoIP (Voice over IP) may be supported to permit direct voice communication as is known in the art. Optionally and preferably, an invitation from one member to another is sent through communication module (9).

The members may also optionally communicate through one or more member forums through a forum module (10). The forums may optionally be viewed by users who are not members of the community and/or are not logged in.

Also the members may optionally share photographs through a photo gallery (11). The photographs are preferably viewable by members who are registered and logged on, but may optionally be viewed by other users as well, more preferably according to the request of the member providing the photograph.

A member may also optionally write a member review (user review) for being displayed through community center server (6). Reviews may optionally be read by users who are not registered and/or logged in. The reviews of professional critics may also optionally be provided through community center server (6).

A member may also optionally and preferably view or receive targeted advertising on or through the on-line site, for example while logged into the on-line site.

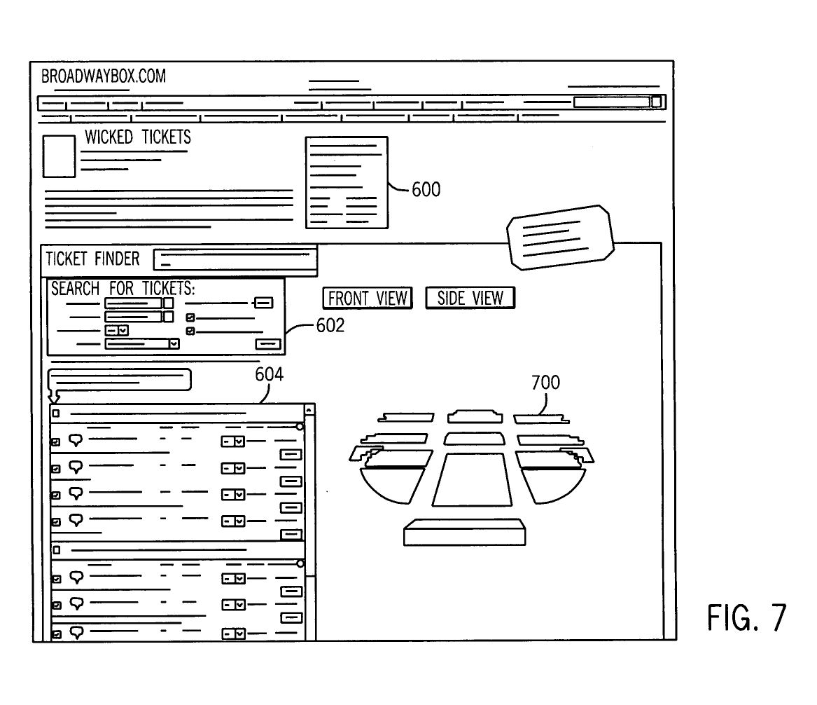

FIGS. 6-9 are screenshots of an exemplary, illustrative non-limiting implementation of the present invention with regard a web site known as “BroadwayBox.com”, constructed by the present inventors and owned in common with the present invention.

FIG. 6 shows an exemplary screenshot for the Broadway show. As shown, information about the show includes reviews of various components of the show, including but not limited to acting, music, production and story (600); links to reviews; links to directions to the theater; and so forth. Information is also provided regarding an exemplary search performed for Apr. 10-11, 2008 through a ticket finder (602), indicating that for example on April 10 and also 11, various tickets are available through the secondary market only (as indicated by “compare at” which shows the original ticket price; see shown results (604)). Ticket prices, numbers of tickets and also seat locations are shown.

The seating map (606) preferably provides information about the seats, including their location, but optionally and preferably also including one or more of whether they offer a partially obstructed view or alternatively whether they may be considered “high quality” seats for viewing this particular show. For example if the user “clicks on” or otherwise selects a particular seat (optionally for example by “mousing over” or by moving the cursor over the seat area with the mouse or other pointing device), preferably information about the seat is then shown.

FIG. 7 shows a screenshot of the search results, also performed for the show for the same dates, but with a three-dimensional seating map (700). Components with the same or similar function as for FIG. 6 have the same reference numbers.

FIG. 8 shows an exemplary seating chart for the show. The location of seats, including such information regarding the degree to which upper levels project over lower levels, is given, along with pricing information according to the primary market. This figure also shows the mechanism for locating a seat in the map. First the user chooses the section, line and row of the desired seat, as shown in the picture. Then, the user optionally presses on the locate button for locating the seat on the map. The system then optionally displays an marker that points to the seat. The user can optionally view details about the seat or purchase the ticket

FIG. 9 shows an entry page for a different show. This entry page indicates that a discount code is available and describes a plurality of different ways to use this discount code in order to purchase tickets at a discount price.

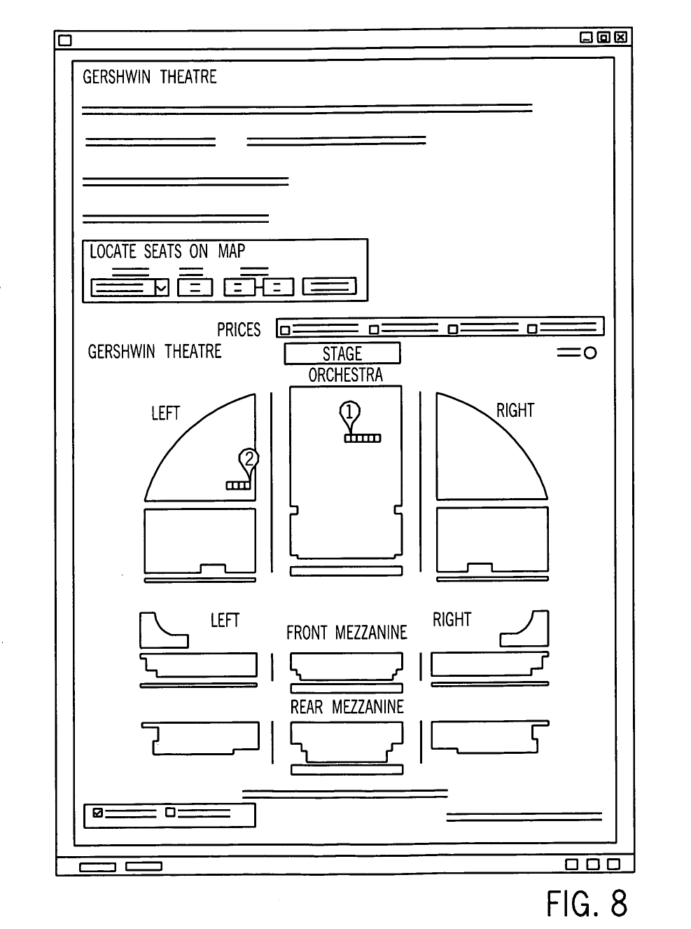

FIG. 10 is a flowchart regarding an exemplary, illustrative method for the map usage. The user is preferably able to view a combination of available ticket information from a plurality of sources via a map. The map optionally illustrates the hall in which the show takes place. Optionally a filter can be used to display on the map only the available seats for specific dates or duration, or a specific show or a specific price, or range of prices, from the primary market, or the secondary market, or any combination of the criteria described herein, or any other criteria. When duration of days filter is chosen, a date filtering is optionally available within the map. Such filtering optionally enables the user to view seats for a specific day only. For example if duration of March 1 to March 3 was chosen, then the user can optionally use a filter to display on the map only the seats that are available for March 1^{st}. When range of prices filter is chosen, for example, a price filtering is optionally available. Such filtering optionally enables the user to view seats for a specific price only. For example if a range of $100-$200 was chosen, then the user can optionally use a filter to display on the map only the seats that are available for $100. The map can optionally be filtered to display seat in different colors according to their prices, quality, or any other criteria. For example, if a price criterion is chosen, full price tickets can optionally be colored in yellow, while discounted tickets can optionally be colored in other colors. If quality filter is chosen, for example, high quality seats can optionally be colored in red, while less quality seats can optionally be colored in deferent colors. If both location and price are chosen then each combination of quality and price can optionally be colored differently. For example high quality and full price seat optionally are colored in blue. The user can optionally be pointed to the exact place of a seat in the map by specifying it's location. Clicking on the desired seat, or using any other pointing mechanism, enables the user to purchase the ticket for this seat, or read comments and details about the seat, or view a photography of the seat and the landscape. The user can optionally view details about each seat such as the availability days, the rating, comments from other user etc.

As shown in more detail in the drawing, the user first chooses a specific show, using one of the methods available in the system, such as wizard, or dialog box, or any other method (11). Then the user chooses the filtering criteria for viewing the available seats for this show (12). Optionally a filter can be used to display on the map only the available seats for specific dates or duration, or a specific show or a specific price, or range of prices, from the primary market, or the secondary market, or any combination of the criteria described herein, or any other criteria. Then the map is opened and displays only the available seats according to the chosen criteria (13). Then, the user can filter the seats according to quality criteria, for example (14). This will cause the display of a map with the available seats according to previously selected criteria such that the high quality seats are colored in one color, while the less quality seats are colored in different color (15). User can point to the specific seat, either by a tool displayed in the map which enables the user to specify the line and row of the seat, or by using the mouse, or any other method (16). The user can then read comments about the seat from optionally a dialog box which is optionally available when clicking on the seat (17). Next the user can optionally view a photograph or drawing of the actual location (18). Next user can purchase the seat from this dialog box (19).

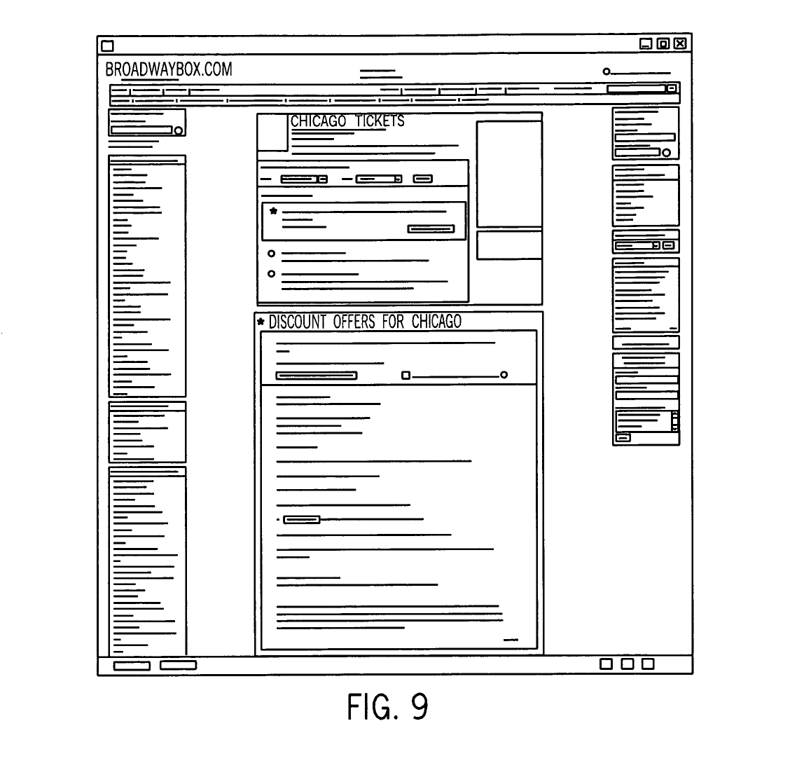

FIG. 11 is a flowchart regarding an exemplary, illustrative method for the usage of the wizard. The wizard is an interactive user interface element that leads the user through a sequence of dialogs. The user can optionally choose the specific show and parameters that are related to the show via the wizard. The wizard guides the user in each step and directs him to the next step. At the end the wizards opens a map that shows the available seats according to the predefined criteria, from which the user can purchase the tickets.

As shown in the drawing, first the user opens the wizard which is preferably displayed on the home page by a special icon (21). Then the user chooses the market from which the tickets will be purchased. The user can optionally choose a primary market, a secondary market or a combination (22). Then the user chooses the show from a list of shows (23), next the user chooses a date or duration of days from a list of available days (24). For example, if the available days for the shows are March 1-March 15 and April 4-April 20, the user can choose March 10-March 10 and April 4 to April 10. Next the user chooses the price or range of prices from available list of prices (25), for example if the available prices are $100-300 then the user can choose $200 as the maximum price and/or the exact price of the ticket. Then a map is displayed showing the user the available seats according to the criteria chosen by the user (26). The method as shown and described is exemplary and illustrative only, as optionally any criterion for choosing a ticket can be applied to the wizard. Optionally the criteria can be displayed in any order.

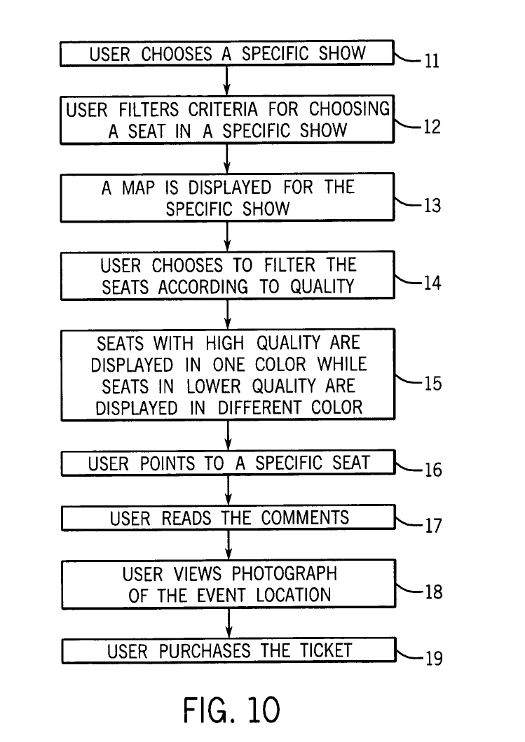

FIG. 12 is a flowchart regarding an exemplary, illustrative method for purchasing a ticket using a discount code. The system enables the purchasing of discount tickets from the primary market (and optionally also the secondary market if available), using a discount code. The primary market sells discount tickets for selected performances for which unsold seats are expected by distributing discount codes. These codes are frequently (but not necessarily) applicable for the mid-week performances, if a show has a discount price in the primary market; the system optionally displays the discount code of the selected show.

As shown in the drawing, the user first issues a request to buy a ticket, using this system (31). The request can be done via wizard, dialog box or any other method. Then the system displays a discount code next to the ticket's price (32). Then, if the user buys the ticket through a telephone order, for example through one of the ticketing companies such as Ticketmaster, the code is used verbally and/or by entering the digits through the telephone in some manner (34). If the user buys the ticket online, optionally by connecting an on-line ticketing company, optionally and preferably via the system of the present invention, the code is used in the online order (36). If the user buys in the theater box office, the discount code is printed from the website and is presented in the box office (36). Of course other types of communication are also possible. The user can optionally enroll through the system for receiving discount codes by email.

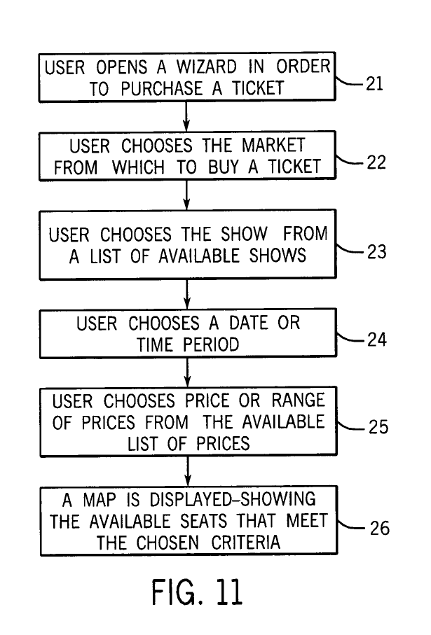

FIG. 13 is a flowchart regarding an exemplary, illustrative method for generating a map. According to other preferred embodiments of the present invention, the system can generate new maps for the specific theater. This feature is available for maps which can be generated by optionally using a wizard, or any other method. As shown in the diagram, first the user to choose the location type (such as stadium, Opera Theater, concert theater, open or partially open theater, and etc) from a list of templates (41), and then optionally specify which sections exist in this theater and optionally provides the name, shape, direction and other relevant parameters referring to this section (42). Possible sections can be, for example centre orchestra, left and right orchestra, balcony etc. Then the number of rows and seats per each section are specified (43), preferably followed by specifying the relevant attributes such as price, availability for handicapped individuals and any other relevant criteria (44). Last the seats are qualified, optionally according to a pre-defined set of rates (45). Optionally more parameters can be used for defining the map. Optionally the definition can be done in any order. Optionally and preferably the map is then submitted and/or saved and/or otherwise stored (46).

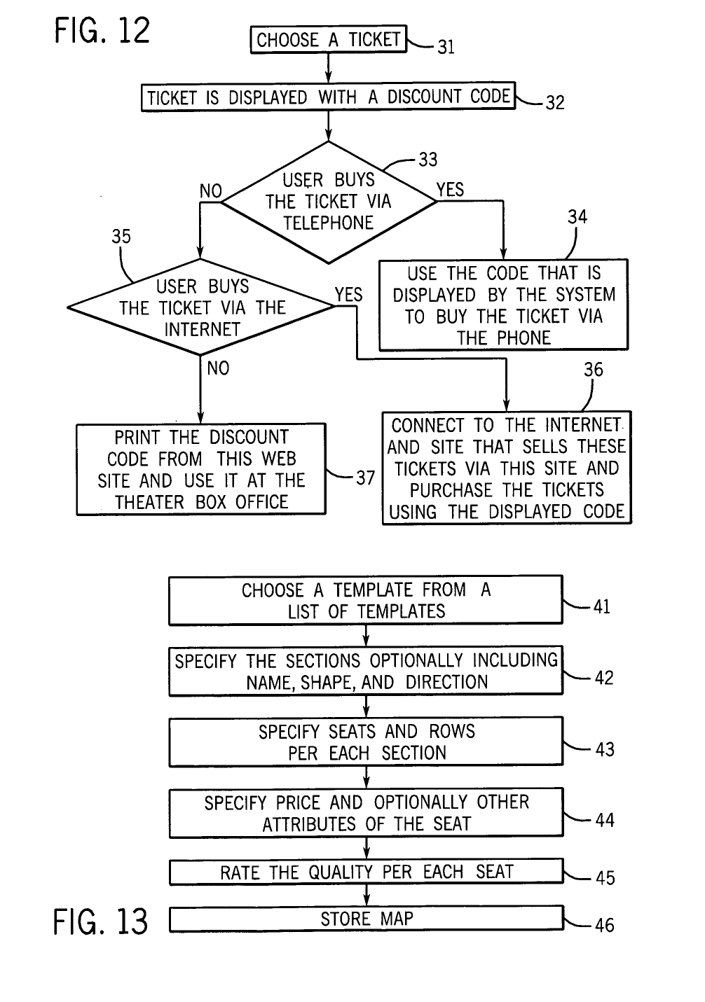

FIG. 14 is a flowchart regarding an exemplary, illustrative method for displaying statistical information about the purchasing of the tickets. The system provides statistical information which helps the ticketing companies or any other entities that are involved in this market to better understand the market and increase the selling by, for example changing the pricing in certain dates etc.

This information is optionally displayed graphically. As shown in the diagram, first the system preferably saves information regarding each purchase (55). The information that is saved is optionally about the show, the theater, the location of the seat, the date of the purchasing, the date of the show, information about the purchaser (if available), etc. The data is optionally aggregated with already existing data in the database. Next when an authorized user requests a specific analyze, the relevant information is optionally taken from the database and used for calculation (56). The result is displayed to the user, optionally by a graph (57). For example, if the user requests to see a graph regarding the distribution of the tickets that are sold for a specific show that is displayed in a specific week, in order, for example, to apply discounts in specific days, the system collects this information and presents a graph showing the number of tickets that are sold per each day that the show takes place. Optionally, the user can request to automatically and periodically collect statistics for an unlimited period of time, or for a predefined duration. The user can optionally stop this automated process at any time. The results are optionally saved on the computer to be shown by this user only and/or are sent to the requester, for example by email. The statistical reports can also be automatically created at pre-set times and delivered by email and/or otherwise delivered.

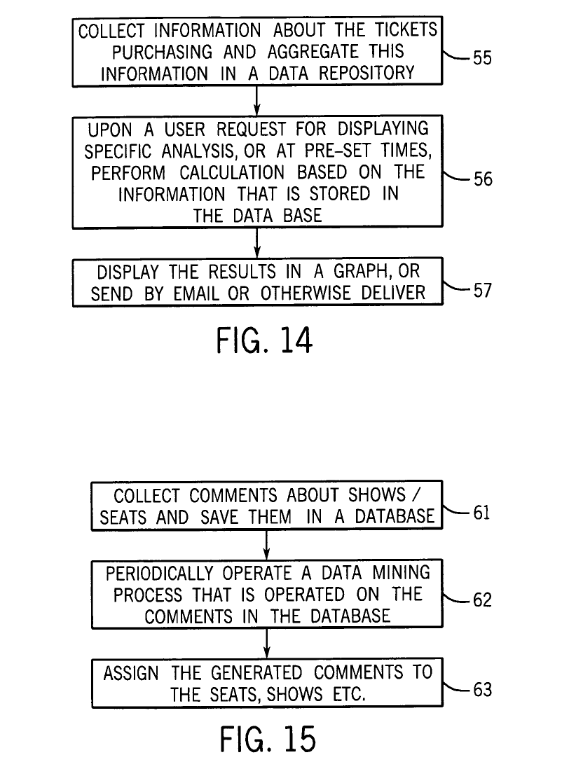

FIG. 15 is a flowchart regarding an exemplary, illustrative method of generating comments and reviews. The system can automatically generate comments regarding seats, shows, theaters, or any other entities in the system, by optionally using text mining for combining comments received from multiple sources such as community, newspapers etc.

As shown in the drawing, the system first saves in the database all the comments that are received from community, newspapers, or any other resources (61). Then a data mining process is periodically and automatically activated (62). The process generates new comments which optionally summarize all the comments that are saved in the database. The data mining process can be optionally based o the number of time that a certain comment appears, the relevant and the importance of the person who made the comment and any other criteria. The new comments are assigned to the items in the system (63). For example summarized comments about a specific seat are preferably assigned to this seat and can optionally be then displayed using the map; also optionally additionally or alternatively, summarized comments about a specific show are optionally assigned to the show.

While the invention has been described with respect to a limited number of embodiments, it will be appreciated that many variations, modifications and other applications of the invention may be made.

What is claimed is:

1. A method for ticket selection for a show, comprising:
Selecting at least one of a plurality of parameters for a ticket, including at least one of a range of dates or availability of a discount or of a ticket in the secondary market or of a ticket in the primary market, and/or a combination thereof;
Searching for a ticket according to said at least one selected parameter; and
Displaying the search results, wherein if information regarding a ticket in the secondary market is provided, said information includes an original price and a current price of said ticket.

2. The method of claim 1, wherein said displaying the search results further comprises displaying information about at least one seat parameter.

3. The method of claim 2, wherein said at least one seat parameter is selected from the group consisting of a value of the seat and a price of the seat.

4. The method of claim 2, wherein said search is performed via a wizard.

5. The method of claim 2, wherein said displaying information about at least one seat parameter further comprises displaying a seating map.

6. The method of claim 5, wherein said seating map comprises a three dimensional model of a show venue.

7. The method of claims 5 or 6 wherein a tool for generating a seating map is provided by the system.

8. The method of claim 2, wherein said displaying information about at least one seat parameter further comprises displaying at least one user review of said seat.

9. A system for selecting a ticket for a show, comprising:
a. a user computer for operating a user interface;
b. a server for providing ticket and show information to said user computer for display on said user interface, said server further comprising a database for storing said ticket and show information; wherein said database is at least partially updated in real time according to information from a seller of tickets for the show.

10. A method for providing information through a community of members as related to shows, comprising:
Providing one or more personal details about the members upon registration, including information about a show-related interest of each member; and
Searching for a member according to said one or more personal details; and
Displaying said one or more personal details.

11. The method of claim 10, wherein said show-related interest includes one or more of theater interests, shows which the user has seen (and which were enjoyed and which were not enjoyed), and/or show(s) which the user would like to see, or a combination thereof.

12. The method of claims 10 or 11, wherein a member invites another member to a show according to said one or more personal details.

13. The method of claim 10, wherein a member organizes a group of members to purchase tickets to a show as a block according to said one or more personal details.

14. The method of claim 10, further comprising collecting statistical information, from the data that is collected by the system, and presenting the information.

15. The method of claim 14, wherein said presenting comprises presenting information in a graph.

16. The method of claim 14, wherein said presenting comprises sending said information to the user.

17. The method of claim 16, wherein said sending comprises sending by email.

18. The method of any of claims 8-17, further comprising providing at least one user review through the community.

19. The method of claim 18, further comprising the processing of the reviews into new summarized reviews and assigning them to items in the system.

20. The method of any of claims 1-8 or 10-19, further comprising providing a discount code for purchasing a ticket.
